(19) United States
(12) Patent Application Publication
(10) Pub. No.: US 2018/0176740 A1
(43) Pub. Date: Jun. 21, 2018

(54) MULTI-RADIO SYSTEM FOR COMMUNICATING VEHICLE POSITION

(71) Applicant: Caterpillar Inc., Peoria, IL (US)

(72) Inventors: Fazal A. GORAYA, Dunlap, IL (US); Erik L. Olsen, Peoria, IL (US); Craig Lawrence Koehrsen, Peoria, IL (US); Kiran Kumar Ram Bharwani, Torrance, CA (US)

(73) Assignee: Caterpillar Inc., Peoria, IL (US)

(21) Appl. No.: 15/380,818

(22) Filed: Dec. 15, 2016

(51) Int. Cl. H04W 4/04; H04H 20/55; H04W 4/02

(52) U.S. Cl. CPC H04W 4/046; H04W 4/023; H04H 20/55

(57) ABSTRACT

A communication system for a mobile machine is disclosed. The communication system may include a plurality of radio transceivers, each of the plurality of radio transceivers including positioning device configured to generate a respective machine position signal. The communication system may further include a processor in communication with each of the plurality of radio transceivers and configured to receive the respective machine position signal generated by the positioning device of each of the plurality of radio transceivers, determine a combined machine position based collectively on the machine position signal generated by the positioning device of each of the plurality of radio transceivers, and communicate the combined machine position to each of the plurality of radio transceivers. Each of the plurality of radio transceivers may be configured to broadcast the combined machine position.

### TECHNICAL FIELD

The present disclosure relates generally to a communication system and, more particularly, to a multi-radio system for communicating a vehicle position.

### BACKGROUND

Large off-highway vehicles, such as large haul trucks, mining trucks, etc., are often operated in the presence of other smaller machines on a worksite. For example, mining trucks are often operated in the presence of smaller transportation vehicles (e.g., pickup trucks) and/or other mining equipment, such as loaders, dozers, and/or other machines. Because mining trucks are so large (i.e., tall, wide, and long), “blind spots” can exist that obstruct or prohibit a mining truck operator's view of nearby vehicles, machines, personnel, etc. That is, the operator's field of vision from the operator station of the vehicle may be limited by the vehicle's own geometry and construction, such that other vehicles and objects of interest nearby are not visible to the operator. To help operators of large equipment, to stay aware of other vehicles' positions, communication systems have been implemented by which the positions of vehicles on a worksite are communicated to one another and are displayed to their operators.

One problem associated with conventional systems for communicating vehicle position is that radio waves sent and received by communication devices (or “radios”) are often unable to pass through certain components of large off-highway vehicles and therefore are not effectively communicated. For example, some mining trucks are so large that the signal path between the truck's radio and the radios of nearby vehicles is blocked by the truck's own bed, body, drivetrain, and/or other components, which are typically formed of thick metal. As a result, the mining truck's radio can be prevented from communicating with other nearby vehicles located on the opposite side of the mining truck from where the radio is mounted. When communication with the mining truck's radio is prevented, the positions of nearby vehicles can remain unknown to the mining truck operator, effectively creating blind spots for the operator.

One attempt to improve the accuracy of a vehicle position and orientation determination and communication system is discussed in U.S. Pat. No. 9,099,003 to Dedes et al. (the '003 patent) that issued on Aug. 4, 2015. The system of the '003 patent includes a GNSS antenna, and IMU or distributed accelerometer sensor, and other additional sensory equipment that generate position and orientation data of a host vehicle. The host vehicle data from each device or sensor is received by a data fusion processor that processes the combined data to estimate the position and orientation of the host vehicle with respect to neighboring vehicles. The data fusion processor estimates and monitors the trajectories of nearby vehicles and estimates deviations of the vehicles from expected trajectories, such as roadway departures, obstacle avoidance maneuvers, and lane departures. The data fusion processor generates and receives safety warning signals from other vehicles through a Vehicle-2-Vehicle communication system and communication module to warn drivers of other vehicles' movements.

While the system of the '003 patent may combine multiple data sources in determining vehicle and orientation, it may not be optimum. For example, the system of the '003 patent employs known wireless communication technologies in the context of roadway vehicles and may not account for communication difficulties experienced by off-highway vehicles due to their size and construction. Further, while the '003 patent addresses the accuracy of location and orientation determinations, it may not address signal transmission difficulties experienced by large off-highway vehicles.

The disclosed communication system is directed to overcoming one or more of the problems set forth above and/or other problems of the prior art.

### SUMMARY

In one aspect, the present disclosure is directed to a communication system for a mobile machine. The communication system may include a plurality of radio transceivers, each of the plurality of radio transceivers including a positioning device configured to generate a respective machine position signal. The communication system may further include a processor in communication with each of the plurality of radio transceivers and configured to receive the respective machine position signal generated by the positioning device of each of the plurality of radio transceivers, determine a combined machine position based collectively on the machine position signal generated by the positioning device of each of the plurality of radio transceivers, and communicate the combined machine position to each of the plurality of radio transceivers. Each of the plurality of radio transceivers may be configured to broadcast the combined machine position.

In another aspect, the present disclosure is directed to a method of communicating position information associated with a mobile machine. The method may include generating a machine position signal from each of a plurality of radio transceivers, communicating the machine signal from each of the plurality of radio transceivers to a processor, determining a combined machine position based collectively on the machine positon signal generated by the positioning device of each of the plurality of radio transceivers, communicating the combined machine position signal to each of the plurality of radio transceivers, and broadcasting the combined machine position signal via each of the plurality of radio transceivers.

In yet another aspect, the present disclosure is directed to a mobile machine. The mobile machine may include at least one traction device connected to a frame, a power source connected to the frame and configured to drive the at least one traction device, an operator station mounted to the frame, the operator station including operator control devices, and a communication system. The communication system may include a plurality of radio transceivers, each of the plurality of radio transceivers including a positioning device configured to generate a respective machine position signal. The communication system may further include a processor in communication with each of the plurality of radio transceivers and configured to receive the respective machine position signal generated by the positioning device of each of the plurality of radio transceivers, determine a combined machine position based collectively on the machine position signal generated by the positioning device of each of the plurality of radio transceivers, and determine a machine heading based on the machine position signal generated by the positioning device of one or more of the plurality of radio transceivers. A first radio transceiver of the plurality of radio transceivers may be configured to generate a basic safety message indicative of the combined machine position and the machine heading and communicate the basic safety message to the others of the plurality of radio transceivers. Each of the plurality of radio transceivers may be configured to broadcast the basic safety message.

### BRIEF DESCRIPTION OF THE DRAWINGS

FIG. 1 is a pictorial illustration of an exemplary disclosed off-highway vehicle interacting with other vehicles on a worksite;

FIG. 2 is a schematic illustration of an exemplary disclosed communication system that may be used with the off-highway vehicle of FIG. 1;

FIG. 3 is a rear view pictorial illustration of the off-highway vehicle of FIG. 1 employing the communication system of FIG. 2; and

FIG. 4 is another schematic illustration of the communication system of FIG. 2.

### DETAILED DESCRIPTION

Reference will now be made in detail to exemplary embodiments that are illustrated in the accompanying drawings. Wherever possible, the same reference numbers will be used throughout the drawings to refer to the same or like parts.

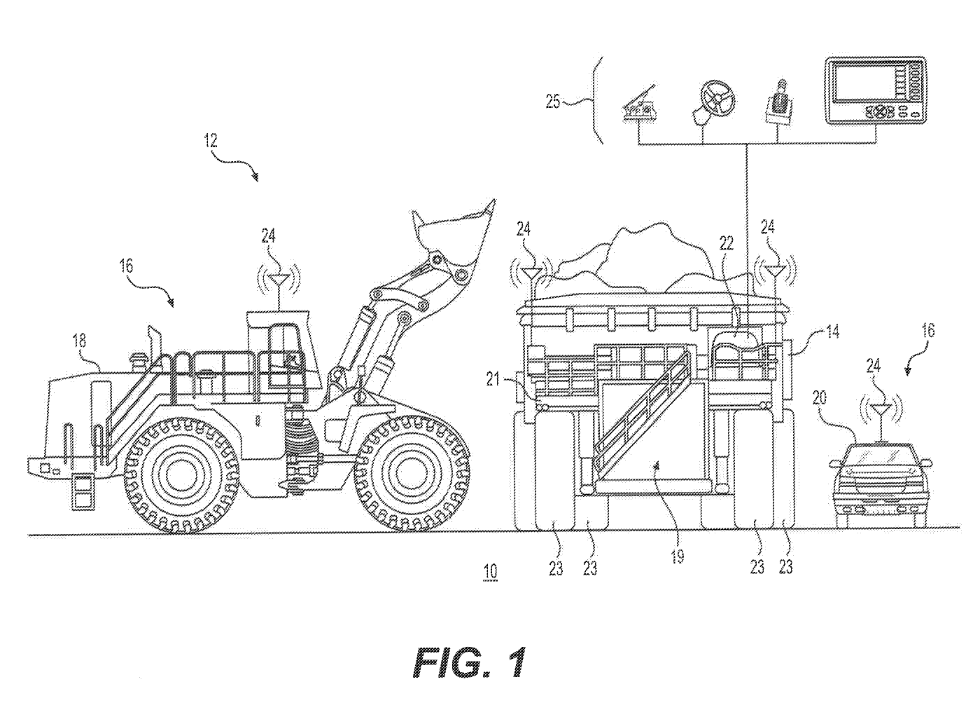

FIG. 1 illustrates an exemplary worksite 10 where a plurality of vehicles 12 may perform various tasks cooperatively or in the presence of each other. For example, as shown in FIG. 1, vehicles 12 may include a mobile machine 14 and/or one or more other vehicles 16. In the example of FIG. 1, mobile machine 14 is depicted as an off-highway vehicle (e.g., a mining truck). However, it should be understood that mobile machine 14 could embody another type of mobile machine, such as a loader, a dozer, a mining shovel, an excavator, etc. The other vehicles 16 shown in Fig. I include another mobile machine 18 and a personnel vehicle 20. Although mobile machine 18 is depicted in FIG. 1 as a wheel loader, it should be understood that mobile machine 18 could alternatively embody any other type of machine, such as a dozer, backhoe loader, skid steer loader, excavator, etc., which may or may not be working cooperatively with mobile machine 14. Personnel vehicle 20 is depicted in FIG. 1 as a utility truck (e.g., a pickup truck), but could alternatively embody any other type of vehicle, such as another mobile machine, a car, etc. It is to be understood that other vehicles 16 may include other or different vehicles or machines, as desired.

On worksite 10, vehicles 12 may work cooperatively or independently to accomplish one or more tasks. For example, as shown in FIG. 1, machine 18 is loading machine 14 with work material to be transported to another location. Personnel vehicle 20 may be driven near machines 14 and 18 simply in passing, or for purposes of bringing. personnel (e.g., machine operators, supervisors, etc.) nearby during shift changes or to observe operations. In any event, vehicles 12 may be independently operated in the presence of one another, which may require vehicle operators to be constantly aware of their surroundings to avoid collisions.

In some situations, one or more of vehicles 12 may be relatively large (such as machine 14) and, due to their stature, geometry, and/or construction, their operator may be provided with a limited line of sight from within an operator station 22. That is, from operator station 22, 22, the operator of machine 14 may have a limited view of other areas and vehicles 12 on worksite 10, including areas and vehicles located to its sides (e.g., its lateral sides), its rear, or at ground level within a certain distance from its wheels. In other words, machine 14 may have one or more “blind spots” where an operator in operator station 22 is not able to visually observe whether or not another of vehicles 12 is nearby.

Machine 14 may further include a power source 19 such as an engine (e.g., an internal combustion engine). In other embodiments, power source 19 may alternatively embody a motor, a battery bank, or another type of power source. Power source 19 may be connected to a frame 21 and operatively connected to at least one (e.g., one or more) traction device(s) 23. Traction devices 23 may also be connected to frame 21 (e.g., via suspension components, steering components, etc.) and include, for example, a plurality of wheels. In some embodiments, some wheels may be operably driven by power source 19 to thereby drive machine 14 over terrain, while other wheels may be configured to rotate and support the vehicle without being driven directly by power source 19. An operator may control how machine 14 is driven (and or other operations of machine 14) from operator station 22. Operator station 22 may include operator controls 25, such as levers, buttons, pedals, switches, display devices, touch screens, steering wheels, and/or other types of control devices configured to receive operator inputs for controlling machine functions and performing other tasks.

To enable vehicles 12 to communicate with one another during operation on worksite 10, each of vehicles 12 may be equipped with a communication device 24. Communication devices 24 may embody devices that facilitate or enable vehicle-to-vehicle communication. For example, communication devices 24 may include radio transceivers (“radios”) configured to send and receive radio signals indicative of data and/or other information. In some embodiments, communication devices 24 may include radios configured to communicate via a type of internet protocol, such as an 802.11 protocol (e.g., 802.11a, 802.11p, etc.). It is to be understood that other types of Internet protocol or other categories of communication protocol may be used.

Communication devices 24 may be configured to communicate, among other information, basic safety messages (BSMs) to other communication device. BSMs may refer to a messaging convention used in vehicle-to-vehicle (V2V) communication for exchanging pieces or categories of information and/or data. In some embodiments, BSMs may refer to, for example, SAE J2735 BSMs or another type of BSM. BSMs may include multiple pieces of data, such as vehicle size (e.g., L×W×H dimensions), position, speed, heading, acceleration, brake system status, and/or other information). BSM information may be used (e.g., process) to convey information to operators and/or control systems of machine 14 and other vehicles 16 for improving operations.

In some non-limiting embodiments, an 802.11p protocol may be used by communication devices 24 for V2V communication, vehicle-to-infrastructure (V2I), and/or “vehicle-to-anything” (V2X) communication. 802.11p is a short range communication protocol that may be more suitable than other protocols for moving vehicle applications. 802.11p data communication occurs at approximately 5.9 GHz frequency, which makes it suitable for V2V communication when vehicles are within a certain distance of each other. However, electromagnetic waves travelling at 5.9 GHz (i.e., as generated by 802.11p devices) can be blocked by certain materials (e.g., thick metal), which can result in communication between multiple communication devices 24 being lost.

For example, machine 14, as a large mining truck, includes several large metal components (e.g., its bed, body, drivetrain, etc.) that can block electromagnetic waves (e.g., radio waves) generated by communication devices 24. Furthermore, due to its large size (e.g., height, length, and width), a single communication device 24 may be incapable generating communication signals that are able to pass through all the metal components of machine 14 to reach another side of machine 14. That is, communication signals generated by a single communication device 24 mounted on one side (e.g., a left side, right side, front side, rear side, top side, bottom side) of machine 14 may not be able to reach another side of machine 14 without being blocked by metal components. As a result, communication between machine 14 and other vehicles 16 on worksite 10 may be lost when the other vehicles 16 are on sides of machine 14 other than the side on which communication device 24 is mounted.

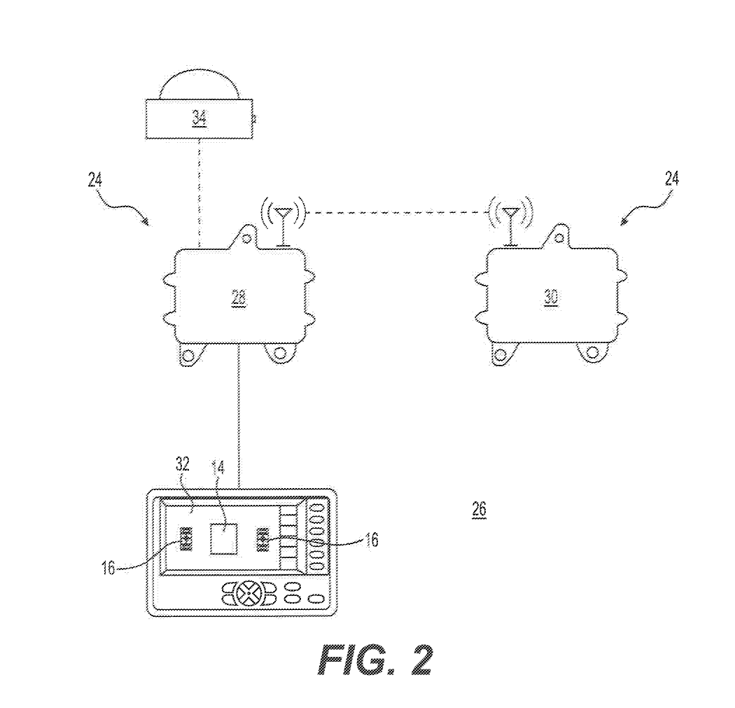

To enable machine 14 to communicate effectively with other vehicles 16 on worksite 10 regardless of which side of machine 14 the other vehicles are located, machine 14 may be equipped with a communication system 26, as shown in FIG. 2. Communication system 26 may be include multiple communication devices 24 (e.g., multiple radios or transceivers) configured to exchange and synchronize information relating to machine 14 and other vehicles 16 for purposes of ensuring machine 14 can communicate effectively with other vehicles 16.

Communication devices 24 of communication system 26 may include multiple radios (i.e., at least two radios). For example, communication system 26 may include a primary radio 28 and a secondary radio 30. Primary radio 28 and secondary radio 30 may be the same type of radio or different types of radios. In some embodiments, primary and secondary radio 28 and 30 may be identical in structure (i.e., they may have been manufactured the same way). For example, primary and secondary radios 28 and 30 may each be the same type of radio configured to perform 802.11p communication (i.e., communication pursuant to 802.11p protocol). Accordingly, the designations “primary” and “secondary” may be indicative of the functions and/or connected structures associated with each respective radio when actually implemented in communication system 26. In other words, any one of the multiple communication devices 24 associated with communication system 26 may be designated as “primary” or “secondary” if configured (e.g., programmed, connected to other devices, etc.) to perform the functions of primary radio 28 or secondary radio 30, respectively, as described herein.

Primary radio 28 and secondary radio 30 may be configured to communicate with each other (e.g., via 802.11p protocol), and primary radio 28 may be further configured to communicate with other components of communication system 26. For example, primary radio 28 may also be configured to communicate with a display device 32. Display device 32 may be or include an LED display, LCD display, CRT display, or other type of display device configured to receive signals and/or show information associated with the signals. In some embodiments, display device 32 may be located in operator station 22 (referring to FIG. 1). For example, display device 32 may be the display device of a machine console; (e.g., a device built-in to operator station 22 of machine 14). In other embodiments, display device 32 may be the display device of a portable or semi-portable electronic device, such as a smartphone, tablet, personal digital assistant (PDA), laptop computer, dedicated electronic device, and/or another type of electronic device). As will be explained below, display device 32 may be configured to display the positions of one or more vehicles 12 (referring to FIG. 1) to an operator (e.g., based on information received via BSM communications). For example, display device may include or be connected to computer hardware and/or software configured to generate graphical images representing the locations of vehicles 12, such as machine 14 and other vehicles 16, on worksite 10 and/or with respect to each other.

In some embodiments, as will be explained below, communication system may include an auxiliary positioning device 34 optionally connected to primary radio 28 and configured to generate a positioning signal associated with machine 14. Auxiliary positioning device 34 may be configured to receive location signals from one or more (e.g., a plurality of) satellites associated with a global navigation satellite system (GNSS), such as Navstar Global Positioning System (GPS), GLONASS, Galileo, Beidou, etc. Auxiliary positioning device 34 may use the positioning signals to determine its own position (e.g., by trilateration) with respect to the coordinate system, which is used to determine the location of machine 14.

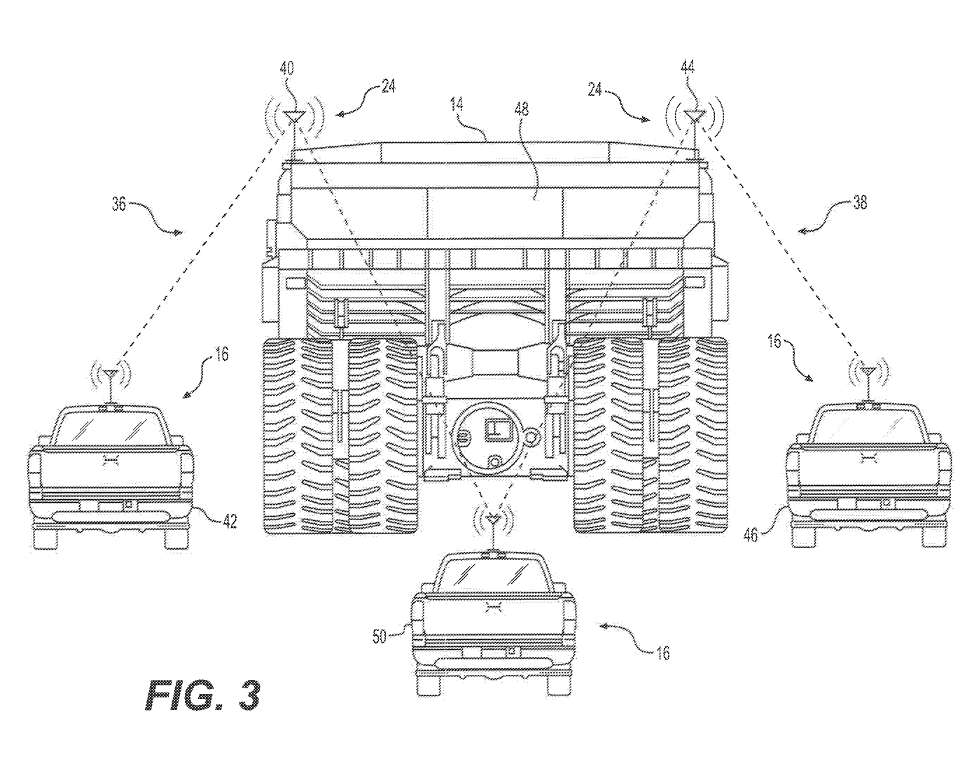

As shown in FIG. 3, communication devices 24 of machine 14 (i.e., those associated with communication system 26 of FIG. 2) may each be mounted to machine 14 on a respective side of machine 14. For example, in some embodiments, a first communication device 24 may be mounted on a first side 36 (e.g., a left side) of machine 14, and a second communication device 24 may be mounted on a second side 38 (e.g., the right side) opposite the first side of machine 14. It should be noted that in other embodiments, communication devices 24 may be positioned on other or additional sides of machine 14, such as its front side, rear side, etc., in order to increase the likelihood that communication with other vehicles 16 is not interrupted.

As shown in FIG. 3, communication devices 24 may be configured to respectively communicate with other vehicles 16 on the respective side 36 or 38 to which the communication device 24 is mounted. For example, a first communication device 40 may be mounted to first side 36 of machine 14 and configured to communicate with at least a first other vehicle 42. As used herein, “first other vehicle” (e.g., with reference to first other vehicle 42) may refer to one or more other vehicles 16 visible from first side 36 of machine 14. A second communication device 44 may be mounted to second side 38 of machine 14 and configured to communicate with at least a second other vehicle 46. As used herein, “second other vehicle” (e.g., with reference to second other vehicle 46) may refer to one or more other vehicles 16 visible from second side 38 of machine 14. In this way, when first communication device 40 is prohibited from communicating with second other vehicle 46, for example due to signal blockage caused by truck bed 48, second communication device 44 may be able to communicate with second other vehicle 46 to ensure BSM communication between machine 14 an second other vehicle 46 is not interrupted. Similarly, when second communication device 44 is prohibited from communicating with first other vehicle 42, for example due to signal blockage caused by truck bed 48, first communication device 40 may be able to communicate with first other vehicle 42 to ensure BSM communication between machine 14 and first other vehicle is not interrupted. In some situations, one of the other vehicles 16, such as, for example, a third other vehicle 50, may be positioned so that first and second communication devices 40 and 44 are able to communicate with vehicle 50. As explained below, communication system 26 may be configured to ensure third other vehicle 50 is detected but not recognized multiple times as separate vehicles.

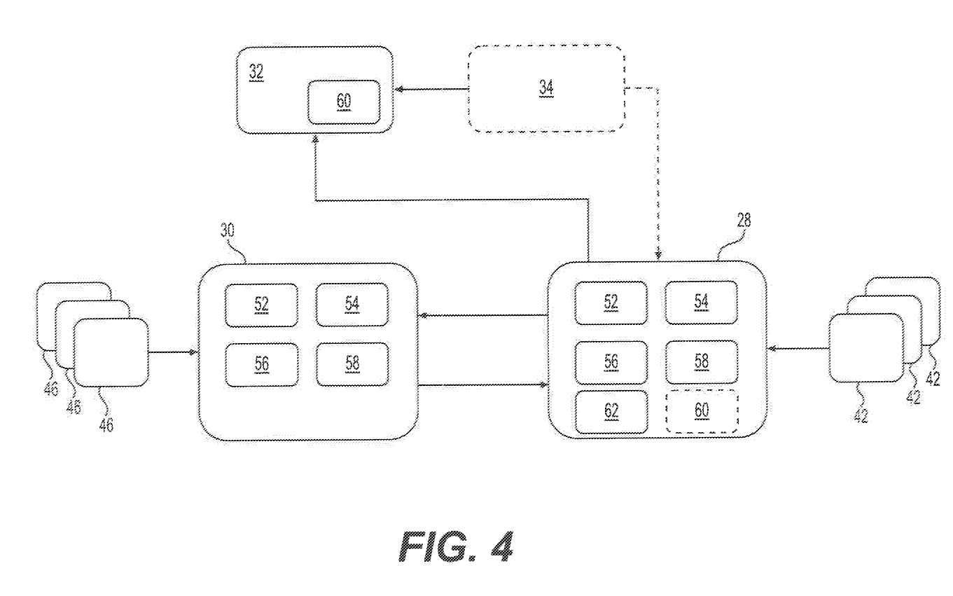

FIG. 4 shows a schematic illustration of communication system 26. Communication system 26 includes primary radio 28 as a first radio transceiver configured to generate a first machine position signal. Primary radio 28 may be referred to as a radio transceiver because primary radio 28 may include a communication receiver 52 and a communication transmitter 54. Communication receiver 52 and communication transmitter 54 may be configured to communicate via 802.11 protocols, such as 802.11p. In this way, primary radio 28 may be configured to communicate (e.g., exchange data, BSMs, and/or other information) with secondary radio 30 and with other vehicles (i.e., other transceivers associated with the other vehicles). For example, primary radio 28 may be configured to communicate with one or more first other vehicles 42 (e.g., with radio transceivers associated with first other vehicles 42 and configured to communicate via 802.11p). In this way, primary radio 28 may be configured to receive data and information from first other vehicles 42, such as a first vehicle position signal from at least one first other vehicles 42. In some embodiments, a first vehicle position signal may be received independently from first other vehicles 42 (e.g., a dedicated first vehicle position signal). In other embodiments, the first vehicle position signal may be part of or included in a BSM signal.

Primary radio 28 may be configured to generate a first machine position signal because primary radio 28 may include a positioning device 56, such as a GPS device or other type of positioning device. That is, primary radio 28 may include positioning device 56 as an internal positioning device (i.e., a built-in positioning device) configured to generate a positioning signal. In this way, primary radio 28 may be able to determine its own position. The positioning signal generated by the positioning device 56 of primary radio 28 may be a first machine position signal because the signal generate by positioning device 56 may be indicative of or associated with the position of machine 14. For example, the position of positioning device 56 of primary radio 28 (e.g., as determined by its positioning signal) may correspond to the same position of the part on machine 14 to which positioning device 56 and primary radio 28 is attached. This position may be related to another position of machine 14, such as a central position of machine 14 (i.e., the position of the center of machine 14), by a known offset distance corresponding to the distance from the center of machine 14 to positioning device 56 of primary radio 28.

Offset information relating to primary radio 28, as well as other information (such as position data, BSM data, computer executable instructions, etc.) may be stored within a memory 58 of primary radio 28. Memory 58 of primary radio 28 may be any suitable non-transitory compute readable medium, such as RAM, ROM, CD-ROM, flash, magnetic disk or tape, etc.

Communication system 26 may also include secondary radio 30 as a second radio transceiver configured to generate a second machine position signal. Secondary radio 30 may be referred to as a radio transceiver because secondary radio 30 may include a communication receiver 52 and a communication transmitter 54. Communication receiver 52 and communication transmitter 54 may be configured to communicate via 802.11 protocols, such as 802.11p. In this way, secondary radio 30 may be configured to communicate (e.g., exchange data, BSMs, and/or other information) with primary radio 28 and with other vehicles (i.e., other transceivers associated with the other vehicles). For example, secondary radio 30 may be configured to communicate with one or more second other vehicles 46 (e.g., with radio transceivers associated with second other vehicles 46 and configured to communicate via 802.11p). In this way, secondary radio 30 may be configured to receive data and information from first other vehicles 42, such as a second vehicle position signal from at least one of second other vehicles 46. In some embodiments, a second vehicle position signal may be received independently from second other vehicles 46 (e.g., a dedicated second vehicle position signal). In other embodiments, the second vehicle position signal may be part of or included in a BSM signal.

Secondary radio 30 may be configured to generate a first machine position signal because secondary radio 30 may include a positioning device 56, such as a GPS device or other type of positioning device. That is, secondary radio 30 may include positioning device 56 as an internal positioning device (i.e., a built-in positioning device) configured to generate a positioning signal. In this way, secondary radio 30 may be able to determine its own position. The positioning signal generated by the positioning device 56 of secondary radio 30 may be a second machine position signal because the signal generated by positioning device 56 of secondary radio may be indicative of or associated with the position of machine 14. For example, the position of the positioning device 56 of secondary radio 30 (e.g., as determined by its positioning signal) may correspond to the same position of the part on machine 14 to which positioning device 56 and secondary radio 30 is attached. This position may be related to another position of machine 14, such as a central position of machine 14 i.e., (the position of the center of machine 14), by a known offset distance corresponding to the distance from the center of machine 14 to the positioning device 56 of secondary radio 30.

Offset information relating to secondary radio 30, as well as other information (such as position data, BSM data, computer executable instructions, etc.) may be stored within a memory 58 of secondary radio 30. Memory 58 of secondary radio 30 may be any suitable non-transitory compute readable medium, such as RAM, ROM, CD-ROM, flash, magnetic disk or tape, etc. In some embodiments, memory 58 of secondary radio 30 may be accessed by and used by primary radio 28 and vice versa. Thus, unless specified, references to memory 58 henceforth may refer to memory 58 of primary radio 28, secondary radio 30, or both.

Communication system 26 may also include a processor 60 in communication with primary radio 28. Processor 60 may be any suitable single microprocessor or multiple microprocessors and/or other components configured to receive inputs from other components of communication system 26 and generating output signals based on the inputs. That is, processor 60 may include processing hardware for accomplishing a task consistent with the present disclosure. Numerous commercially available microprocessors can be configured to perform the functions of processor 60 described herein. It should be appreciated that various other known circuits may be associated with processor 60, including signal-conditioning circuitry, communication circuitry, and other appropriate circuitry.

In some embodiments, as shown in FIG. 4, processor 60 may be included in display device 32 (e.g., as a built-in processor). For example, when display device 32 embodies or is a component of a computational device (such as a computer, smartphone, tablet, laptop computer, FDA, etc.), processor 60 may correspond to the processor or computational hardware of the computational device with which display device 32 is associated. In other embodiments, processor 60 may be included in (e.g., as built into or connected to) primary radio 28. It is to be appreciated that processor 60 may be located elsewhere, if desired.

Processor 60 may be configured to determine a machine position (i.e., the position of machine 14) based on the first and second machine position signals generated by primary and secondary radios 28 arid 30, respectively. For example, processor 60 may be configured determine a position, such as a central position, of machine 14 based on position data received via the first and second machine position signals in conjunction with known offsets and machine dimensions (e.g., length, width, height, etc.) stored in memory 58.

Processor 60 may also be configured to communicate the machine position to the at least first and second other vehicles 42 and 46 via primary and secondary radios 28 and 30, respectively. For example, after processor 60 determines the position of machine 14, processor 60 may communicate the machine position to primary radio 28 (if not included therein) where communication transmitter 54 of primary radio may be configured to transmit the machine position to first other vehicles 42. Communication transmitter 54 of primary radio 28 may also transmit the machine position to secondary radio 30, where the machine position (i.e., a signal indicative of the machine position) may be received by communication receiver 52 of secondary radio 30. Secondary radio may then transmit the machine position via its communication transmitter 54 to second other vehicles 46. In this way, a single machine position value may be determined and disseminated via primary and secondary radios 28 and 30 to first and second other vehicles 42 and 46, thereby ensuring that all other vehicles on worksite 10 receive the same position information indicative of the location of machine 14. That is, without coordinating the machine position information received by each of primary secondary radio 28 and 30, each radio may broadcast a different position value (which could each be separately detected by a single other vehicle), thereby potentially providing inaccurate information as to the true location of machine 14. Communication system 26 avoids such problems by coordinating the position information generated by primary and secondary radios 28 and 30 prior to broadcasting the machine position to any other vehicle on worksite 10.

In embodiments where communication system includes auxiliary positioning device 34, processor 60 may be configured to determine the machine position based on an auxiliary machine position signal generated by auxiliary positioning device 34. For example, if machine 14 includes an auxiliary positioning device 34, which may generate more accurate positioning information (i.e., of a smaller margin of error), the more accurate position information generated by auxiliary positioning device 34 may be used to more accurately determine the position (such as the central position) of machine 14 using known offsets in a similar manner as described above.

Processor 60 may also be configured to determine a machine heading based on the first and second machine position signals generated by primary and secondary radios 28 and 30, respectively. Whereas it may be difficult to determine a machine heading using only a single source of position information, communication system 26 may advantageously enable processor 60 to also determine a machine heading using two sources of position information (i.e., the position signals generated by primary and secondary radios 28 and 30). When machine further includes auxiliary positioning device 34, processor 60 may determine the machine heading based further on the auxiliary machine position signal generated by auxiliary positioning device 34, thereby generating the machine heading more accurately. Processor 60 may be configured to then communicate the machine heading to primary radio 28, which may then communicate the machine heading to first other vehicles and to secondary radio 30. Secondary radio 30 may then communicate the machine heading to second other vehicles. In this way, communication system 26 may allow each other vehicle on worksite 10 to receive the same heading information for machine 14.

As discussed above, information, such as machine position, machine heading, and or other information associated with machine 14 may be communicated to other vehicles (e.g., first and second other vehicles 42 and 46) via BSM communications. To ensure each of the other vehicles on worksite 10 receive the same BSM information for machine 14 (and without machine 14 being detected multiple times by any one of the other machines), primary radio 28 may be configured to generate a basic safety message indicative of the machine position and the machine heading and communicate the basic safety message to secondary radio 30 the first other vehicles. That is, primary radio may include a BSM module 62, which may be part of or accessible by processor 60. BSM module 62 may include hardware (e.g., memory, processing hardware, etc.) and/or software configured to generate (or for generating) a BSM for machine 14. The BSM generated by (or using) BSM module 62 may include other standard BSM information (as described above) in addition to the machine position and heading. Primary radio 28 may be configured to then (after the BSM is generated) communicate the BSM to secondary radio 30. Secondary radio 30 may then communicate the BSM to second other vehicles 46. In this way, communication system 26 may be configured to ensure every other vehicle within broadcast distance (e.g., a broadcast distance reachable using 802.11p) of machine 14, on multiple sides of machine 14, receives the same BSM information for machine 14, thereby avoiding any discrepancies in information.

Primary radio 28 and secondary radio 30 may also be configured to receive BSM signals from first and second other vehicles 42 and 46, respectively. In this way, BSMs from vehicles on multiple sides of machine 14 may be received, thereby reducing or eliminating the possibility that any one of the other vehicles on worksite 10 is not detected by machine 14 due to signal blocking. BSM information received from first and second other vehicles 42 and 46 may include standard BSM information (as described above), which may include the position and heading of each of the other vehicles, respectively. In some situations, however, one of the other vehicles (e.g., third other vehicle 50 shown in FIG. 3) may be positioned to communicate with both primary and secondary radios 28 and 30. To ensure any one of the other vehicles on worksite 10 is not inappropriately perceived twice by machine 14, primary radio 28 may be configured to consolidate position information received from first other vehicles 42 (received via primary radio 28) and second other vehicles 46 (received via secondary radio 30). For example, secondary radio 30 may be configured to send position information (e.g., received via BSM signals or otherwise) from second other vehicles 46 to primary radio 28. Primary radio 28, having received position information from first other vehicles 42 (e.g., via BSM signals or otherwise) may be configured to determine the position of any one or more of the other vehicles 42 and 46 based on the position information received via both primary and secondary radios. Primary radio 28 may be configured to associate pieces of duplicative data (e.g., when one or more of the first and second other vehicles 42, 46, is detected twice) as a single piece of information (e.g., as a single vehicle). In this way, situations in which any one of the other vehicles on worksite 10 is perceived as multiple vehicles may be avoided.

As described above, communication system 26 may include display device 32, Display device 32 may be in communication with primary radio 28, as described above. Display device may be configured to generate a graphical map of worksite 10 and display the location of machine 14 as well as the locations of other vehicles on worksite 10 (e.g., first and second other vehicles 42, 46. In some embodiments, processor 60 may be configured to generate the graphical map on display device 32 using position information received from primary radio 28. For example, primary radio 28 may be configured to transmit position data indicative of the position of other vehicles 42 and 46 (e.g., the position information received via primary radio 28 and/or secondary radio 30) to display device 32 (e.g., when processor 60 is built-into or embedded in display device 32). In this way, the graphical map generated and displayed on display device 32 may include (i.e., may show) the positions of other vehicles 42 and 46. Communication system 26 may therefore prevent communication “blind spots” from obscuring any of the other vehicles 42 and 46 from being displayed on display device 32. When display device 32 is not associated with processor 60 (e.g., when processor 60 is associated with, built into, or embedded in primary radio 28), primary radio 28 may also communicate the position of machine 14 to display device for indicating the position of machine 14 on the graphical map displayed for the user.

### INDUSTRIAL APPLICABILITY

The disclosed communication system finds potential application in any situation where a vehicle's ability to participate in vehicle-to-vehicle communication is obstructed or prevented by structural and/or geometric features of the vehicle. The disclosed communication system finds particular applicability with off-highway trucks, such as mining trucks, that operate on worksites in the presence of other vehicles, such as other machines and smaller transportation vehicles that are not easily seen from the operator station. One skilled in the art will recognize, however, that the disclosed communication system could be utilized in relation to other types of vehicles or other situations where the geometry or structural features of a vehicle prevent effective radio communication from one side of the vehicle to another. An exemplary method of communicating position information associated with a mobile machine will now be explained.

During operation, one or more other vehicles (e.g., at least one first or at least one second other vehicle 42 and 46) may be near machine 14. Machine 14 may include at least two radios (e.g., primary and secondary radios 28 and 30). It is to be understood that additional radios may be used. For example, in some embodiments, machine 14 may be equipped with a primary radio and multiple secondary radios. In this way, machine 14 may be able to send and receive radio transmissions without breaks in communication caused by signal blocking (e.g., due to the size and/or geometry of machine 14).

Primary radio 28 may receive position data (e.g., via a position signal or a BSM signal) from one of the first other vehicles 42 indicative of a position of the other vehicle 42. Secondary radio may receive position data (e.g., via a position signal or a BSM signal) from one of the second other vehicles 46 indicative of a position of the other vehicle 46. In other embodiments, only one of primary and secondary radios 28 and 30 receives position data from one of a first other vehicle 42 or a second other vehicle 46. Alternatively, primary and secondary radios 28 and 30 may each receive a signal from one other vehicle (e.g., a third other vehicle 50). Primary and secondary radios 28 and 30 may also include respective first and second positioning devices 56 configured to generate machine position signals (e.g., first and second machine position signals, respectively) indicative of a position associated with machine 14 at the location at which they are respectively mounted to machine 14. Secondary radio may communicate the machine position data generated by its positioning device 56 as well as the position data generated by second other vehicles 46 to primary radio 28 for further processing.

Primary radio may then consolidate the vehicle data received by primary and secondary radio 23 and 30. For example, primary radio 23 may identify duplicative pieces of position data based on the position data itself (and/or other data, such as vehicle identification data associated with a received BSM signal) and consolidate the data to avoid the possibility that any one vehicle is perceived twice.

At the same time, processor 60 may receive machine position data from primary and secondary radios 28 and 30 and determine a machine position (i.e., the position of machine 14), such as a central position of machine 14, and heading based on the machine position data and/or known offsets stored in memory 58. In some embodiments, processor 60 may determine the position of machine 14 based further on auxiliary machine position data received from auxiliary positioning device 34.

Primary radio 28 may then transmit the locations (or location data) of the other machines first and second other machines 42 and 46) to display device 32. When processor 60 is associated with primary radio 28, the primary radio may also transmit the position of machine 14 to display device 32. Processor 60 may then generate a graphical map on display device 32 configured to show the position of machine 14 as well as the positions of first and second vehicles 42 and 46 on worksite 10. The user may be able to observe the positions of other vehicles 42 and 46 while maneuvering machine 14 in order to avoid collisions with vehicles the operator would not otherwise be able to see.

Primary radio may also generate a BSM for machine 14 based on the position and heading of machine 14 and transmit the BSM to first other vehicles 42 and to secondary radio 30. Secondary radio 30 may then transmit the BSM to second other vehicles 46. In this way, the other vehicles 42 and 46 on worksite 10 may be provided with the same position, heading, and/or other information relating to machine 14.

Because communication system 26 utilizes multiple radios (i.e., first and second radios 28 and 30) to communicate with first and second other vehicles 42 and 46, several advantages may be realized. For example, by using multiple radios instead of, for example, a single radio with multiple antennas, the cost of communication cable between the single radio and the multiple antennas may be eliminated. The cost of cables can be significant and can quickly outweigh the cost of using multiple radios for purpose of ensuring communication signals can be sent and received from multiple sides of machine 14. Further, it can be difficult to determine a machine's heading using only a single source of position data (e.g., a single radio). Having multiple radios associated with communication system 26 may provide for an easier and more accurate determination of machine heading.

It will be apparent to those skilled in the art that various modifications and variations can be made to the communication system of the present disclosure. Other embodiments of the communication system will be apparent to those skilled in the art from consideration of the specification and practice of the communication system disclosed herein. It is intended that the specification and examples be considered as exemplary only, with a true scope being indicated by the following claims and their equivalents.

What is claimed is:

1. A communication system for a mobile machine, comprising:
a plurality of radio transceivers, each of the plurality of radio transceivers including a positioning device configured to generate a respective machine position signal;
a processor in communication with each of the plurality of radio transceivers and configured to:
receive the respective machine position signal generated by the positioning device of each of the plurality of radio transceivers;
determine a combined machine position based collectively on the machine position signal generated by the positioning device of each of the plurality of radio transceivers; and
communicate the combined machine position to each of the plurality of radio transceivers;
wherein each of the plurality of radio transceivers is configured to broadcast the combined machine position.

2. The communication system of claim 1, wherein:
each of the plurality of radio transceivers is positioned at respective offset distance from a reference point on the mobile machine; and
the processor is configured to determine the vehicle position based collectively on the machine position signal generated by the positioning device of each of the plurality of radio transceivers and the respective offset distance of each of the plurality of radio transceivers.

3. The communication system of claim 1, wherein:
the system includes an auxiliary positioning device configured to generate an auxiliary machine position signal; and
the processor is configured to determine the machine position based on the auxiliary machine position signal.

4. The communication system of claim 1, the processor is configured to determine a machine heading based on the machine position signal generated by the positioning device of one or more of the plurality of radio transceivers.

5. The communication system of claim 4, wherein:
a first radio transceiver of the plurality of radio transceivers is configured to generate a basic safety message indicative of the machine position and the machine heading; and communicate the basic safety message to the others of the plurality of radio transceivers; and
each of the plurality of radio transceivers is configured to broadcast the basic safety message.

6. The communication system of claim 1, wherein:
the plurality of radio transceivers are configured to receive one or more signals indicative of position information of one or more other vehicles and communicate the position information to a first radio transceiver of the plurality of radio transceivers; and
the processor is configured to determine a position of at least one of the one or more other vehicles based on the position information communicated to the first radio transceiver by the plurality of radio transceivers.

7. The communication system of claim 6, wherein the processor is mounted to one of the first radio transceiver and a display device in communication with the first radio transceiver.

8. The communication system of claim 6, wherein the processor is configured to display the position of the at least one of the one or more other vehicles on the display device.

9. The communication system of claim 1, wherein:
a first radio transceiver of the plurality of radio transceivers is mounted to the machine on a first side of the machine; and
a second radio transceiver of the plurality of radio transceivers is mounted to the machine on a second side of the machine opposite the first side.

10. The communication system of claim 9, wherein the processor is configured to:
determine a first position of at least a first other vehicle based on first position information received via the first radio transceiver; and
determine a second position of at least a second other vehicle based on second position information received via the second radio transceiver.

11. A method of communicating position information associated with a mobile machine, the method comprising:
generating a machine position signal from each of a plurality of radio transceivers;
communicating the machine signal from each of the plurality of radio transceivers to a processor;
determining a combined machine position based collectively on the machine positon signal generated by the positioning device of each of the plurality of radio transceivers;
communicating the combined machine position signal to each of the plurality of radio transceivers; and
broadcasting the combined machine position signal via each of the plurality of radio transceivers.

12. The method of claim 11, wherein:
each of the plurality of radio transceivers is positioned at respective offset distance from a reference point on the mobile machine; and
the method further includes determining the vehicle position based collectively on the machine position signal generated by the positioning device of each of the plurality of radio transceivers and the respective offset distance of each of the plurality of radio transceivers.

13. The method of claim 11, further including:
generating an auxiliary machine position signal via an auxiliary positioning device; and
determining the machine position based on the auxiliary machine position signal.

14. The method of claim 11, further including determining a machine heading based on the machine position signal generated by the positioning device of one or more of the plurality of radio transceivers.

15. The method of claim 14, further including:
generating a basic safety message via a first radio transceiver of the plurality of radio transceivers, the basic safety message being indicative of the machine position and the machine heading and communicating the basic safety message from the first radio transceiver to the others of the plurality of radio transceivers; and
broadcasting the basic safety message via each of the plurality of radio transceivers.

16. The method of claim 11, further including:
receiving, via the plurality of radio transceivers, one or more signals indicative of position information of one or more other vehicles and communicating the position information to a first radio transceiver of the plurality of radio transceivers; and
determining a position of at least one of the one or more other vehicles based on the position information communicated to the first radio transceiver by the plurality of radio transceivers.

17. The method of claim 16, further including displaying the position of the at least one of the one or more other vehicles on a display device in communication with the first radio transceiver.

18. The method of claim 11, further including:
receiving first position information from at least a first other vehicle on a first side of the mobile machine via a first radio transceiver of the plurality of radio transceivers; and
receiving second position information from at least a second other vehicle on a second side of the mobile machine opposite the first side via a second radio transceiver of the plurality of radio transceivers.

19. The method of claim 11, further including:
determining a first position of the at least first other vehicle based on the first position information received via the first radio transceiver; and
determining a second position of the at least second other vehicle based on the second position information received via the second radio transceiver.

20. A mobile machine, comprising:
at least one traction device connected to a frame;
a power source connected to the frame and configured to drive the at least one traction device;
an operator station mounted to the frame, the operator station including operator control devices; and
a communication system including:
a plurality of radio transceivers, each of the plurality of radio transceivers including a positioning device configured to generate a respective machine position signal; and
a processor in communication with each of the plurality of radio transceivers and configured to:
receive the respective machine position signal generated by the positioning device of. each of the plurality of radio transceivers;
determine a combined machine position based collectively on the machine position signal generated by the positioning device of each of the plurality of radio transceivers;
determine a machine heading based on the machine position signal generated by the positioning device of one or more of the plurality of radio transceivers;
wherein a first radio transceiver of the plurality of radio transceivers is configured to generate a basic safety message indicative of the combined machine position and the machine heading and communicate the basic safety message to the others of the plurality of radio transceivers; and
wherein each of the plurality of radio transceivers is configured to broadcast the basic safety message.
